(19) United States
(12) Patent Application Publication
(10) Pub. No.: US 2025/0231805 A1
(43) Pub. Date: Jul. 17, 2025

(54) SYSTEMS AND METHODS FOR REDUCING EXCESS RESOURCE USAGE

(71) Applicant: AMGEN INC., Thousand Oaks, CA (US)

(72) Inventors: Simon J. Bannon, Dublin (IE); Ankur Mukesh Amlani, Cambridge, MA (US); Patrick Rory Luce Keating, Dublin (IE)

(21) Appl. No.: 18/853,977

(22) PCT Filed: Apr. 4, 2023
(86) PCT No.: PCT/US23/17366

§ 371 Date: Oct. 3, 2024

Related U.S. Application Data
(60) Provisional application No. 63/327,435, filed on Apr. 5, 2022.

(51) Int. Cl. G06F 9/50

(52) U.S. Cl. CPC G06F 9/5027

(57) ABSTRACT

Systems, methods, and computer-readable medium storing instructions for characterizing a recipe of a production system for producing a product include receiving (a) specification limits of a product parameter of the product, (b) resource allocation input information, and (c) historical product information, generating a model that models a relationship between each of a respective proposed target value and both (a) resource allocation impact information and (b) process capability impact information, and displaying or storing the model. In some aspects, displaying the model includes displaying a relationship between each of the respective proposed target values and both (a) resource allocation impact information, and (b) process capability impact information. Further aspects include causing the production system to operate using a selected target value.

### FIELD OF THE DISCLOSURE

The present application relates generally to characterizing a recipe of a production system for producing a product, such as a drug product (e.g., in a drug product filling system), and to more efficient use of resources in a production system.

### BACKGROUND

Production systems may produce products with specification limits, such as an upper limit and/or a lower limit, with which the product should comply. Specification limits may relate to measurable quantities of product parameters. The product parameters may be one or more characteristics such as mass, temperature, time, electric current, luminous intensity amount of substance, length, height, width, thickness, weight, volume, area, circumference, diameter, perimeter, density, voltage, resistivity, pH, viscosity, etc. A product with product parameters not in compliance with the specification limits may be less desirable, or in some cases unusable, in which case the product (and possibly an entire batch, if the non-compliant product was produced in the batch) may have to be discarded. When there is only one specification limit, such as only a lower specification limit (LSL), or only an upper specification limit (USL), production systems may produce according to a recipe with a target value that is sufficiently far from the one specification limit. For example, if there is only a LSL for a product, a production system may produce a product according to a recipe with a target value for a product parameter that is sufficiently larger than the LSL. The amount by which the product parameter value is larger than the LSL is referred to herein as “necessary excess resource (NER) usage.”

A production system may be used for production of a product via unit production, batch production, mass production, or continuous production. Production systems may be used in commercial production (e.g., production of parts for goods or whole goods), scientific production (e.g., production of resources or equipment for scientific research), or other types of production.

One example of a production system is a product filling system. Product filling systems may be used for filling a container with solid, liquid, and/or gaseous product. Product filling systems may be manual (e.g., operated by a hand lever used to pump product through a tip), semi-automatic (e.g., operated by pumps controlled by an operator), or automatic (e.g., operated by pumps controlled by a computing device) Product filling systems may also be used across a variety of disciplines and industries, including, for example, life sciences/engineering, chemical sciences/engineering, medical sciences/engineering, mechanical sciences/engineering, food sciences/engineering, beverage sciences/engineering, as well as manufacturing and assembly corresponding to the aforementioned disciplines and industries.

Product filling systems are often used in pharmaceutical development, pharmaceutical testing and trials, and pharmaceutical production. A pharmaceutical liquid filling system is one type of product filling system. Pharmaceutical liquid filling systems ranging in in operation size from small to large are used by many pharmaceutical firms. These pharmaceutical liquid filling systems exist in many formats, from small bench tops to large-scale machines, and may accommodate many different product properties such as liquid viscosities.

In pharmaceutical production, specification limits are often used. Specification limits of a pharmaceutical production system may be imposed by a regulatory entity, such as a governmental entity (e.g., the Food and Drug Administration). In some pharmaceutical production applications, a single product unit may be a container (e.g., vial, syringe, cartridge, tube, beaker, cup, or any other suitable holding structure) filled with a liquid drug composition of a fill volume such that, at a later time, a specified volume of the liquid drug composition may be withdrawn from the container to administer to a patient. In some examples, withdrawing the specified volume of the liquid drug from the container includes moving the specified volume of the liquid drug into another container (e.g., a syringe) prior to administration, while in other examples, the specified volume of the liquid drug may be withdrawn from the container directly into the patient (e.g., via injection if the container is a syringe). Therefore, the fill volume must be greater than or equal to the specified volume (also known as “label volume”). In some pharmaceutical production examples, specification limit(s) may include either: (i) only a LSL, or (ii) an USL and a LSL, wherein for both examples, the LSL is equal to the sum of (i) a volume specified in a product label of a pharmaceutical product (also referred hereto as label volume) and (ii) a hold-up volume. In practice, the fill volume and LSL are not equal (i.e., the fill volume is greater than the LSL); instead, a target value is selected for the product parameter of fill volume to ensure that the fill volume is larger than the LSL by a NER usage amount. Specifically, since the target value pertains to volume, the NER usage for this case may be referred to as a “necessary excess volume” (NEV) amount. The NEV ensures that, even with natural variation that exists in pharmaceutical production systems for filling the container with the liquid drug composition, there will be enough of the drug in the container to allow for the specified volume of the drug to be administered to a patient. Once the specified volume of the drug is administered (e.g., via a syringe), the NEV of the drug remaining in the container may be discarded. In this example, a larger target value for fill volume corresponds to a greater NEV (and more wasted drug product) and fewer units of drug products produced outside the LSL due to natural variability in production systems.

Conventionally, for many different types of production systems, a target value for product parameters of a recipe may be determined based on historical actual values of product parameters, specifically using the mean and standard deviation of the historical actual values of the product parameters. However, with these conventional methods, only one target value may be determined, providing no insight to an operator of the production system as to whether the target value is too conservative or not conservative enough with respect to a rate at which the production system produces units outside the specification limit(s). Furthermore, the operator is not provided with any insight as to how changing the target value may impact resource allocation and/or process capability. With these conventional methods, production systems will routinely be set to operate at a target value that is overly conservative with respect to the specification limit(s) and, accordingly, will have inefficiencies in resource allocation.

### BRIEF SUMMARY

One aspect of the present disclosure provides a method for characterizing a recipe of a production system for producing a product, including: (a) receiving, by one or more processors, one or more specification limits of a product parameter of the product; (b) receiving, by the one or more processors, resource allocation input information; (c) receiving, by the one or more processors, historical product information for a number of batches, the historical product information including: (i) a plurality of historical actual values for the product parameter, and (ii) one or more historical target values for the product parameter; (d) generating, by the one or more processors applying the specification limits, the resource allocation input information, and the historical product information, a model that, for each of a plurality of proposed target values for the product parameter, models a relationship between the respective proposed target value and both (i) resource allocation impact information and (ii) process capability impact information; and (e) displaying and/or storing, by the one or more processors, the model.

In some aspects, displaying the model of previous aspects includes displaying, by the one or more processors for each of the proposed target values, a relationship between the respective proposed target value and both (i) resource allocation impact information and (ii) process capability impact information.

In some aspects, the product of the previous aspect is a drug and the production system of the previous aspect is a filling system.

In some aspects, the previous aspects further include causing, by the one or more processors, the production system to operate using a selected target value.

Another aspect of the present disclosure provides computer-readable media storing instructions that, when executed by one or more processors, cause the one or more processors to perform the method of any one of the previous aspects.

Another aspect of the present disclosure provides a system including, (a) one or more processors; and (b) one or more non-transitory, computer-readable media storing instructions that, when executed by the one or more processors, cause the one or more processors to perform the method of any one of the previous aspects.

### BRIEF DESCRIPTION OF THE DRAWINGS

The skilled artisan will understand that the figures described herein are included for purposes of illustration and are not limiting on the present disclosure. The drawings are not necessarily to scale, emphasis instead being placed upon illustrating the principles of the present disclosure. It is to be understood that, in some instances, various aspects of the described implementations may be shown exaggerated or enlarged to facilitate an understanding of the described implementations. In the drawings, like primary characters throughout the various drawings generally refer to functionally similar and/or structurally similar components.

FIG. 1 is a simplified block diagram of an example system for characterizing a recipe of a production system for producing a product.

FIG. 2 depicts an example graphical display that may be generated by the user interface unit of FIG. 1.

FIG. 3 depicts an example process for determining annual savings for a proposed target value.

FIG. 4 depicts an example output table relating proposed target values to both resource allocation impact information and process capability impact information.

FIG. 5 depicts an example comparison between product output of conventional methods and the presently disclosed techniques when applied to a product filling system.

FIG. 6 is a flow diagram depicting an example method for characterizing a recipe of a production system for producing a product.

### DETAILED DESCRIPTION

The present disclosure aims to reduce problems with conventional techniques (e.g., as described in the Background section) by providing techniques for characterizing a recipe of a production system for producing a product. The present techniques may include generating a model that, for each of a plurality of proposed target values for the product parameter, models a relationship between the respective proposed target value and both (i) resource allocation impact information and (ii) process capability impact information. Via generating and displaying and/or storing the model, the techniques aim to characterize a recipe of a production system to provide insight to an operator of the production system regarding the plurality of proposed target values, thereby avoiding the numerous disadvantages associated with conventional techniques.

When an operator of a production system makes decisions regarding setting a target value for the production system, it is advantageous for the operator to have certain insights related to resource allocation impacts (or a likelihood associated with one or more possible resource allocation impacts) and process capability impacts (or a likelihood associated with one or more possible process capability impacts) of multiple different proposed target values. Accordingly, the operator may use these insights generated by the present techniques to, for example, improve performance and/or efficiency of the production system.

Advantageously, by providing improved insights, the present techniques may reduce the conventional practice of selecting a target value that is excessively far from a specification limit. For example, as applied to applications with at least a LSL, NER usage may be reduced. Reducing NER usage brings numerous advantages. One advantage of reducing NER usage is that less resource (e.g., drug product) are used for producing each unit of the product. Accordingly, resource waste is decreased, resource efficiency is increased, and sustainability of the production system is improved. By making the production system more sustainable with respect to resource use, energy efficiency of the production system may also be improved, as less energy may be required to produce each unit of the product. Furthermore, by making the production process more sustainable with respect to resource use, the financial and/or economic cost of producing each unit of the product may also be reduced. Another advantage of reducing NER usage is that production throughput may increase due to more units of the product being produced in a given amount of time. Another advantage, particularly relevant to computational and/or computer-related applications, is that by reducing NER, computational processing resources (e.g., time, power, memory, etc.) may be reduced.

Another advantage of reducing NER usage is that product shortages may be prevented or reduced in frequency as less resources (which may be scarce) are used to produce each unit of product. In pharmaceutical production systems, this may be especially important as a shortage of a drug may have significant health implications for patients who are unable to acquire a medically-necessary drug and instead may have to either substitute for a less-effective drug, or even no drug at all. Accordingly, by reducing occurrences of drug shortages, present techniques may alter which drugs, an order of drugs, and/or a timing of how drugs are administered to a patient, thereby improving patient care and outcome.

Another advantage of reducing NER usage which is especially relevant to pharmaceutical production systems is reduction in fraudulent drug pooling. Drug pooling may occur as a result of an entity which administers drugs combining NER for multiple units of a drug to form an additional unit of the drug. In some instances, this practice may be against regulations and/or laws, and thereby may constitute fraud. By reducing NER usage for each unit of a drug, it becomes increasingly difficult to pool drugs. Accordingly, present techniques may reduce certain fraudulent practices.

It is also worth noting that while NER usage may be reduced, according to present techniques, which may lead to a more frequent occurrence of a unit of product being produced with product parameters outside of specification limit(s) (out-of-specification (OOS) products), this does not necessarily mean that there will be any effect on product acquired by a customer. Products that are OOS may be flagged by a production system and may be discarded. For example, in a pharmaceutical production system, units of a drug that are below a LSL (e.g., the label volume plus the hold-up volume) may be removed such that patients will not receive the units of the drug that are OOS.

Additional advantages of the to present techniques over conventional approaches characterizing a recipe of a production system for producing a product will be appreciated throughout this disclosure by one having ordinary skill in the art. The various concepts and techniques introduced above and discussed in greater detail below may be implemented in any of numerous ways, and the described concepts are not limited to any particular manner of implementation. Examples of implementations are provided below for illustrative purposes.

### Exemplary System

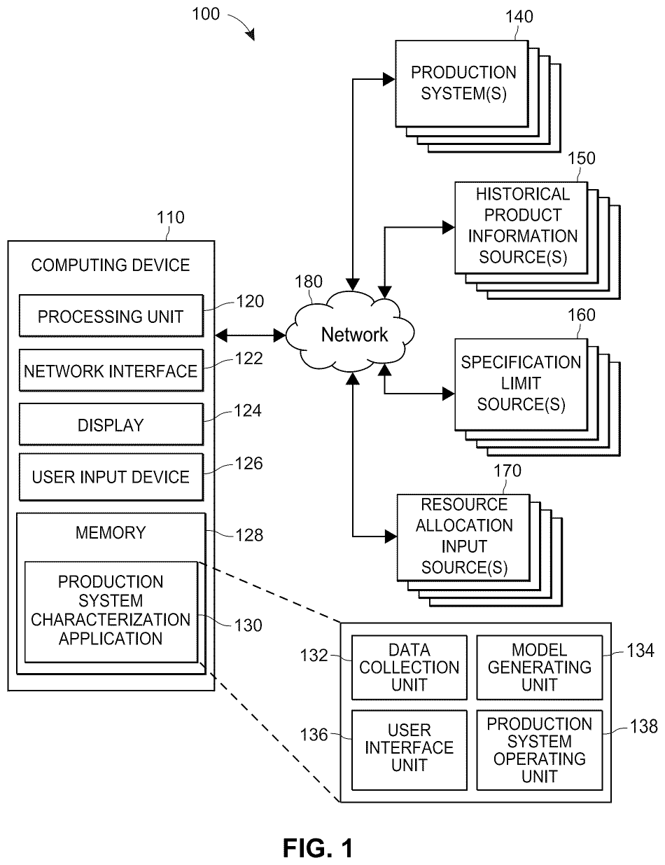

FIG. 1 is a simplified block diagram of an example system 100 for characterizing a recipe of a production system for producing a product. In some aspects, the system 100 may include standalone equipment, though in other examples the system 100 may be incorporated into other equipment. At a high level, the system 100 includes the client computing device 110, one or more production systems 140, one or more historical product information sources 150, one or more specification limit sources 160, and one or more resource allocation input sources 170, one or more at least some of which may be communicatively coupled via a network 180 that may be a proprietary network, a secure public internet, a virtual private network, or some other type of network, such as dedicated access lines, plain ordinary telephone lines, satellite links, cellular data networks, combinations of these, etc. Where the network 180 comprises the Internet, data communications may take place over the network 180 via an Internet communication protocol. In some aspects, more or fewer instances of the various components of the system 100 may be included (e.g., one instance of the computing device 110, five instances of the production systems 140, ten historical product information sources 160, etc.) may be included in the system 100.

As previously discussed, the computing device 110 may be included in the system 100. The computing device 110 may include a single computing device, or multiple computing devices that are either co-located or remote from each other. The computing device 110 is generally configured to: (a) receive one or more specification limits of a product parameter of the product; (b) receive resource allocation input information; (c) receive historical product information for a number of batches, the historical product information including: (i) a plurality of historical actual values for the product parameter, and (ii) one or more historical target values for the product parameter; (d) generate by applying the specification limits, the resource allocation input information, and the historical product information, a model that, for each of a plurality of proposed target values for the product parameter, models a relationship between the respective proposed target value and both (i) resource allocation impact information and (ii) process capability impact information; and (e) display and/or store the model.

Components of the computing device 110 may be interconnected via an address/data bus or other means. The components included in the computing device 110 may include a processing unit 120, a network interface 122, a display 124, a user input device 126, and a memory 128, discussed in further detail below.

The production systems 140 may include a single production system, or multiple production systems that are either co-located or remote from each other. The production systems 140 may generally include physical devices configured for use in producing (e.g., manufacturing) a product. In embodiments where the production systems 140 are product filling systems, the production systems 140 may be used for drug filling, chemical filling, or biological matter filling, for example. In other embodiments, the production systems 140 include equipment that is used in a process unrelated to pharmaceutical development or production (e.g., a food or beverage production system, an oil production system, etc.).

The production systems 140 may include one or more sensors, which may provide sensor data regarding operation of the production systems 140. Such sensor data may be provided to the computing device 110 via the network 180. The production systems 140 may be configured to be controllable via manual or automated inputs. In some embodiments, the production systems 140 may be configured to receive such control inputs locally, such as via a user input device local to the production systems 140. In some embodiments, the production systems 140 are configured to receive control inputs remotely, such as from the computing device 110 via the network 180. The control inputs may include operation instructions, such as one or more target values according to which the production systems 140 should operate.

As noted above, the example system 100 includes one or more historical product information sources 150, one or more specification limit sources 160, and one or more resource allocation input sources 170. Each of one or more of the sources 150-170 may be a single source or include multiple sources that are either co-located or remote from each other. One or more of the sources 150-170 may provide information to the computing device 110 via the network 180. The provided information may be data, such as nominal data, ordinal data, discrete data, and/or continuous data. The provided information may be in the form of a suitable data structure, which may be stored in a suitable format such as of one or more of: JSON, XML, CSV, etc. One or more of the sources 150-170 may provide information to the computing device 110 automatically, and/or in response to a request. For example, a user of the computing device 110 may wish to generate a model that, for each of a plurality of proposed target values for the product parameter, models a relationship between the respective proposed target value and both (i) resource allocation impact information and (ii) process capability impact information. In response, one or more of the sources 150-170 may send information to the computing device 110 via the network 180. One or more of the sources 150-170 may be databases of information themselves and/or may be configured to receive information, such as via user input.

The historical product information sources 150 generally include historical product information that may correspond to one or more batches of production of one or more products having one or more product parameters by one or more production systems (e.g., production systems 140). The historical product information may include, for each of the one or more batches: (i) a plurality of historical actual values for the product parameter, and (ii) one or more historical target values for the product parameter. The historical actual values of the product parameter may include historical actual values for the product parameter that the production system produced, and the historical target values for the product parameter may be the corresponding target values according to which the production system was instructed to operate. To illustrate, for an exemplary liquid drug filling system producing a drug, the drug may have a product parameter of weight. The historical target value for the liquid drug filling system may be, for example, 5.00 grams, and the liquid drug filling system may have produced ten batches of the drug with the historical target value. The historical actual values may include, for example, an average weight of all drugs in a batch for each of the ten batches of the drug produced, such as, {4.98 grams, 5.00 grams, 4.92 grams, 4.94 grams, 5.02 grams, 5.08 grams, 5.08 grams, 5.06 grams, 4.95 grams, 5.01 grams}.

The specification limit sources 160 may generally provide one or more specification limits of one or more product parameters of one or more products. The specification limits may include upper specification limits and/or lower specification limits. The specification limits may include one or more values of a product parameter. Specification limits may be applied on a per-unit, per-batch level, and/or per-production system level. To illustrate, and returning to the exemplary liquid drug filling system described above, there may be a LSL of an average weight of 4.95 grams applied on a per-batch level. Based on the historical actual values provided in the example above, the batches with an average weight of 4.98 grams, 5.00 grams, 5.02 grams, 5.08 grams, 5.06 grams, 4.95 grams, and 5.01 grams are within the specification limit (and may be referred to as “in-spec”), while the batches with an average weight of 4.92 grams and 4.94 grams are outside the specification limit (and may be referred to as “OOS”).

The resource allocation input sources 170 may generally provide resource allocation input information, which may be useful in determining resource allocation impact information of various proposed target values. The resource allocation input information may include financial input information (e.g., what are financial costs associated with producing the product), material input information (e.g., how much of a raw material is used in producing the product), energy input information (e.g., how much energy is used in producing the product), labor input information (e.g., how much labor is used in producing the product), and/or other scarce/finite resource input information.

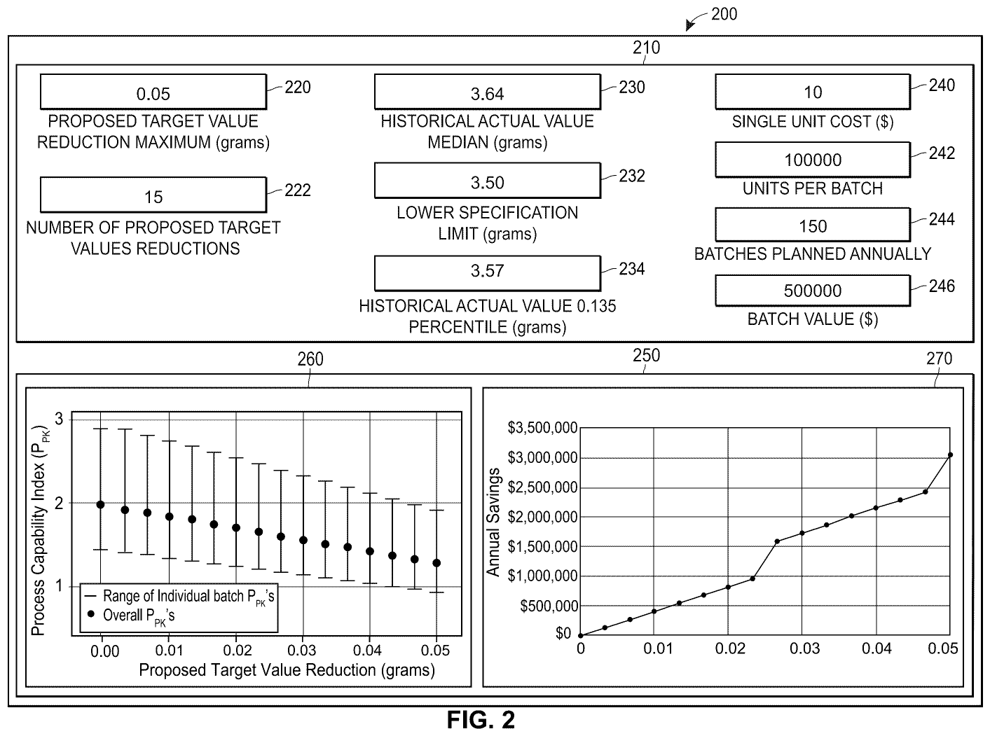

In some embodiments, the system 100 may omit one or more of sources 150-170, and instead receive information/data locally, such as via user input. Techniques for receiving information/data corresponding to sources 150-170 without using sources 150-170 are further described and illustrated, for example, in FIG. 2.

Referring again to the computing device 110, the processing unit 120 includes one or more processors, each of which may be a programmable microprocessor that executes software instructions stored in the memory 128 to execute some or all of the functions of the computing device 110 as described herein. Alternatively, one or more of the processors in the processing unit 120 may be other types of processors (e.g., application-specific integrated circuits (ASICs), field-programmable gate arrays (FPGAs), etc.).

The network interface 122 may include any suitable hardware (e.g., front-end transmitter and receiver hardware), firmware, and/or software configured to use one or more communication protocols to communicate with external devices and/or systems (e.g., the production systems 140, the historical product information sources 150, the specification limit sources 160, the resource allocation input source(s) 170, etc.). For example, the network interface 122 may be or include an Ethernet interface. The computing device 110 may communicate with any device(s) that provide an interface between the computing device 110 via a single communication network, or via multiple communication networks of one or more types (e.g., one or more wired and/or wireless local area networks (LANs), and/or one or more wired and/or wireless wide area networks (WANs) such as the Internet or an intranet, etc.).

The display 124 may use any suitable display technology (e.g., LED, OLED, LCD, etc.) to present information to a user, and the user input device 126 may be a keyboard or other suitable input device. In some aspects, the display 124 and the user input device 126 are integrated within a single device (e.g., a touchscreen display). Generally, the display 124 and the user input device 126 may combine to enable a user to interact with graphical user interfaces (GUIs) or other (e.g., text) user interfaces provided by the computing device 110, e.g., for purposes such as displaying one or more flow profiles, displaying parameters, recommending changes to one or more parameters, notifying users of equipment faults or other deficiencies, etc.

The memory 128 includes one or more physical memory devices or units containing volatile and/or non-volatile memory, and may or may not include memories located in different computing devices of the computing device 110. Any suitable memory type or types may be used, such as read-only memory (ROM), solid-state drives (SSDs), hard disk drives (HDDs), etc. The memory 128 stores instructions of one or more software applications that can be executed by the processing unit 120, including a product system characterization (PSC) application 130. In the example system 100, the PSC application 130 includes a data collection unit 132, a model generating unit 134, a user interface unit 136, and a production system operating unit 138. The units 132-138 may be distinct software components or modules of the PSC application 130, or may simply represent functionality of the PSC application 130 that is not necessarily divided among different components/modules. For example, in some embodiments, the data collection unit 132 and the user interface unit 136 are included in a single software module. Moreover, in some embodiments, the units 132-138 are distributed among multiple copies of the PSC application 130 (e.g., executing at different components in the computing device 110), or among different types of applications stored and executed at one or more devices of the computing device 110.

The data collection unit 132 is generally configured to receive (via, e.g., sources 150-170, user input received via the user interface unit 136, or other suitable means) one or more specification limits of a product parameter, resource allocation input information, and/or receive historical product information including: (i) a plurality of historical actual values for the product parameter, and (ii) one or more historical target values for the product parameter. The model generating unit 134 is generally configured to generate, by applying the specification limits, the resource allocation input information, and the historical product information collected/received by the data collection unit 132, a model that, for each of a plurality of proposed target values for a product parameter, models a relationship between the respective proposed target value and both (i) resource allocation impact information and (ii) process capability impact information. The user interface unit 136 is generally configured to receive a selected target value of proposed target values and/or display the model generated by the model generating unit 134. The production system operating unit 138 is generally configured to cause a production system to operate using a selected target value (e.g., a user selection received via the user interface unit 136). In other embodiments, unit 138 is omitted (e.g., production systems are instead manually configured with selected target values). The operation of each of the units 132-138 is described in further detail below, with reference to the operation of the system 100.

### Exemplary Graphical Display

FIG. 2 depicts an example graphical display 200 of a user interface for receiving input and displaying an output model. The graphical display 200 includes an input interface 210 and an output interface 250. The graphical display 200 may be presented on a display, such as the display 124 of the computing device 110 (e.g., when generated by the user interface unit 136). In other embodiments, the information shown on graphical display 200 may instead be split among two or more graphical display (e.g., windows presented on two or more monitors of two or more co-located or remote devices), and may include additional and/or different information as compared to the example of FIG. 2

One or both of the input interface 210 or the output interface 250 may be configured to facilitate receiving input, such as from the computing device 110, possibly via the network 180. In some aspects the input may be user input which may be received via, for example, the user input device 126 via the user interface unit 136 of the computing device 110. In some aspects, the user input may include input (such as, one or more of: specification limits, resource allocation input information, or historical product information) used in generating a model that, for each of a plurality of proposed target values for the product parameter, models a relationship between the respective proposed target value and both (i) resource allocation impact information and (ii) process capability impact information. In some aspects, the user input may include inputs for affecting the display of the model (e.g., zooming in or zooming out of the model, filtering out certain data points, or other performing other formatting operations to the model). In some aspects, the input may be non-user input, such as input from a source, such as the sources 150-170. When the input is non-user input, the input interface 210 may use the network interface 122 via the data collection unit 132 of the computing device 110 to facilitate receiving the input. In some aspects, the non-user input, similar to the user input, may include inputs for generating and/or displaying the model.

One or both of the input interface 210 or the output interface 250 may be configured to facilitate providing output, such as to components of the system 100, possibly via the network 180. The output may have been first received (e.g., as input) by one or both of the input interface 210 or the output interface 250. For example, the input interface 210 may first receive user input that includes inputs for generating a model. Then, the input interface 210 may facilitate providing the inputs, as outputs to be received by the model generating unit 134 so that the model may be generated.

The input interface 210 may include any number of inputs for receiving: (a) one or more specification limits of a product parameter of the product, (b) resource allocation input information, and (c) historical product information for a number of batches. As illustrated, the example input interface 210 includes: a proposed target value reduction maximum input 220, a number of proposed target value reductions input 222, a historical actual value median input 230, a lower specification limit input 232, a historical actual value 0.135 percentile input 234, a single unit cost input 240, a units per batch input 242, a batches planned annually input 244, and a batch value input 246.

Inputs 220, 222 are indicative of which proposed target values will be included in the model. The proposed target values may be measured in any suitable quantity related to product parameters (e.g., grams, liters, volts, inches, degrees, etc.). As illustrated, inputs 220-222 relate to proposed target value reductions, which may correspond to reducing a baseline target value by varied amounts according to the proposed target value reductions. The baseline target value may be a historical target value, or some other target value. Specifically, input 220 may be for a proposed target value reduction maximum measured in grams (which is entered to be {0.05}, as illustrated) and input 222 may be for a number of proposed target value reductions (which is entered to be {15}, as illustrated). Accordingly, there will be 15 proposed target values included in the model with proposed target value reductions ranging from 0 grams to 0.05 grams, as illustrated.

While the input interface 210 is illustrated as including the proposed target value reduction maximum input 220 and the number of proposed target value reductions input 222, other inputs may instead or also be used to establish how many and which proposed target values are to be included in the model. In one example, the proposed target values may be a list of individual proposed target values, e.g., the list may be: {1, 4, 6, 7, 10, 22} signaling each of those values should be proposed target values. In another example, the target values may include one or more exclusive/inclusive ranges of the proposed target values with either a number of proposed target values or a stepsize of the proposed target values, e.g., the ranges may be: {20, 30} which may signal proposed target values should fall in the range of 20-30, and the number of proposed target values may be: {5} which may signal 4 proposed target values should be included over the range with an equal stepsize (e.g., {20.0, 22.5, 25.0, 27.5, 30.0}) or the stepsize may be: {2} which my signal include proposed target values over the range with a stepsize of 2 (e.g., {20, 22, 24, 26, 28, 30}).

Inputs 230-234 are indicative of: (a) one or more specification limits of a product parameter of a product, and (b) historical product information for a number of batches, the historical product information including: (i) a plurality of historical actual values for the product parameter, and (ii) one or more historical target values for the product parameter. The historical actual value information and the specification limits, and thus inputs 230-234, may be used for determining process capability information. The specification limits and historical product information may be measured in any suitable units corresponding to the relevant product parameters (e.g., grams, liters, volts, inches, degrees, etc.). As illustrated, inputs 230-234 relate to historical product information and specification limits. Specifically, input 230 may be for a historical actual value median measured in grams (which is entered to be {3.64}, as illustrated), input 232 may be for a lower specification limit measured in grams (which is entered to be {3.50}, as illustrated), and input 234 may be for a historical actual value 0.135 percentile measured in grams (which is entered to be {3.57}, as illustrated). Accordingly, the historical value information will include that, for historical actual values, the median value is 3.64 grams and the 0.135th percentile historical actual value is 3.57 grams, as illustrated. Furthermore, the LSL will be 3.50 grams, as illustrated.

While the input interface 210 is illustrated as including the historical actual value median input 230, the lower specification limit input 232, and the historical actual value 0.135 percentile input 234, other inputs may be used in addition or in alternative for providing specification limit(s) and/or historical actual value information. In one example, there may be an input for list(s) of raw historical actual values themselves, on a per-unit, per-batch, and/or per-production system level. In another example, a mean historical actual value may an input. In another example, percentile other than 0.135 may be an input. In another example, an USL may be an input. In another example, a standard deviation of the historical actual values may be an input. Any number of other inputs may be inputs relating to specification limits and/or historical actual value information useful in determining process capability information.

Turning next to inputs 240-246, inputs 240-246 are indicative of resource allocation impact information of various proposed target values. As illustrated, inputs 240-246 relate to financial information, and accordingly may be referred to as examples of “financial input information” used in determining resource allocation impact information related to financial impact information. Specifically, input 240 may be for a single unit cost measured in dollars (which is entered to be {10}, as illustrated), input 242 may be for units per batch (which is entered to be {100000}, as illustrated), input 244 may be for batches planned annually (which is entered to be {150}, as illustrated), and input 246 may be for batch value measured in dollars (which is entered to be {500000}, as illustrated). Accordingly, as illustrated, there may be a cost of production of $10 per unit assuming 100000 units included per batch, 150 batches planned to be produced per year, and a value/profit of $500000 per batch produced.

While the input interface 210 is illustrated as including the single unit cost input 240, the units per batch input 242, the batches planned annually input 244, and the batch value input 246, other suitable financial input information may be used in addition or in alternative for determining financial impact information. For example, rather than single unit cost input, a cost per unit of material (e.g., cost per grams ($/g.) or cost per inch ($/in.), etc.) may be used. In another example, rather than batches planned annually, batches planned over a different time period may be used.

Furthermore, while the input interface 210 includes inputs 240-246 directed to financial input information, other suitable resource allocation input information may be used in addition or in alternative for determining resource allocation impact information, of various proposed target values, that does not necessarily include financial impact information. In some aspects, resource allocation impact information includes material impact information (e.g., how much of a raw material will be used in production), energy impact information (e.g., how much energy will be used in production), labor impact information (e.g., how much of labor resources will be used in production), or other scarce/finite resource usage, based respectively on material input information, energy input information, labor input information, or other scarce/finite resource input information. It is also worth noting, in some aspects, resource allocation impact information may further include throughput impact information (e.g., how much of a unit may be produced in a given amount of time), based on throughput input information.

The output interface 250 may include any number of outputs for displaying the model (or a representation of the model) that, for each of a plurality of proposed target values for a product parameter, models a relationship between the respective proposed target value and both (i) resource allocation impact information and (ii) process capability impact information. As illustrated, the output interface 250 includes: a process capability impact information output 260 and a resource allocation impact information output 270. While each of the outputs 260, 270 includes a graph, any suitable data visualization technique(s) may be used such as: one or more of: charts, tables, plots, graphs, maps, diagrams, histograms, etc. More specific examples of suitable data visualization techniques may include one or more of: bar charts, pie charts, donut charts, half donut charts, multilayer pie charts, line charts, scatter plots, cone charts, pyramid charts, funnel charts, radar triangles, radar polygons, area charts, tree charts, flowcharts, tables, geographic maps, icon arrays, percentage bars, gauges, radial wheels, concentric circles, Gantt charts, circuit diagrams, timelines, Venn diagrams, histograms, mind maps, dichotomous keys, Pert charts, choropleth maps, Cartesian graphs, box and whisker plots, Hexbin plots, heat maps, pair plots, KDE charts, time series charts, correlograms, violin plots, raincloud plots, stem-and-leaf plots, bubble charts, pictogram graphs, or other suitable data visualization techniques. As previously discussed, the outputs 260, 270 of the output interface 250 may be able to be reformatted or manipulated either automatically, or in response to a request. For example, either graph included in outputs 260, 270 may be configured to zoom in or zoom out in response to user feedback.

The process capability impact information output 260 may display a model of a relationship between each of a number of proposed target values and process capability impact information. In the output 260, process capability index (Pₚₖ) is plotted as a function of proposed target value reduction (measured in grams) for each of a proposed target value reduction point. Each of the proposed target value reduction points may have been based on inputs from the input interface 210. The proposed target value reduction points plotted in the output 260 are based on input 320 and 322, as illustrated, and accordingly the proposed target value reduction points include 15 proposed target value reduction points, increasing in 15 equal increments up to 0.05 grams. As illustrated, a baseline target value point of 0 grams of target value reduction (corresponding to the historical target value, as illustrated) is also included in output 260.

For each proposed target value reduction point in output 260, the output 260 includes a Pₚₖ, as illustrated. Pₚₖ is one example of information that may be included in process capability impact information. Pₚₖ is an index which measures a production system's overall process capability of a process in meeting specification limits, and more specifically is a ratio that compares (1) distance from the process mean to the closest specification limit, and (2) one-sided spread of the process (the 3-0 variation) based on overall variation of the process. Accordingly. Pₚₖ may be calculated according to the general equation:

$${P}_{pk} = min [ \frac{USL - \overline{x}}{3 σ} , \frac{\overline{x} - LSL}{3 σ} ] , \qquad ( Equation 1 )$$

where x is the historical actual value mean and σ is the historical actual value standard deviation. However, for certain production systems in which a normal distribution does not apply, a different variation of the general formula may apply. The Pₚₖ values for each of the proposed target value reduction points included in the output 260 may be determined by using the following equation for a non-normal distribution:

$${P}_{pk} = min [ \frac{USL - ( \tilde{x} + Δ x )}{\tilde{x} - {x}_{0.00135}} , \frac{( \tilde{x} + Δ x ) - LSL}{\tilde{x} - {x}_{0.00135}} ] , \qquad ( Equation 2 )$$

where x is the baseline target value, Δx is a proposed target value reduction for a proposed target value reduction point, x_{0.00135} is the 0.135^{th} percentile historical actual value. As illustrated, LSL may be either the closer limit or the only specification limit, and therefore Equation 2 may be refined to define the following equation for Pₚₖ:

$${P}_{pk} = \frac{( \tilde{x} + Δ x ) - LSL}{\tilde{x} - {x}_{0.00135}} . \qquad ( Equation 3 )$$

Accordingly, as illustrated, Pₚₖ is determined using Equation 3 based on inputs 230-234. As noted on the output 260, in addition to showing an overall Pₚₖ for each proposed target reduction value, ranges of individual batch's Pₚₖ values are also shown, which may depict Pₚₖ for a worst-case batch and a best-case batch for each proposed target reduction value.

As illustrated in output 260, as target value reduction increases, Pₚₖ decreases, demonstrating that as target value approaches LSL, process capability will be reduced as individual batches are more likely to be produced OOS. As illustrated, the baseline target value has the highest Pₚₖ, with Pₚₖ=2. A Pₚₖ=2 corresponds to a 6-σ level with a process yield of 99.9999998%, or a process fallout of 0.002 ppm. It is understood that a Pₚₖ=2 corresponds to a relatively high process capability production system. Conversely, as illustrated, a target value reduction point of 0.05 grams corresponds to Pₚₖ=1.3, which in turn corresponds to a process yield of about 99.99%, or a process fallout of about 63 ppm, as illustrated. Therefore, as illustrated, with a target value reduction of 0.05, process capability is worse than the baseline target value.

While Pₚₖ is illustrated in output 260, any other suitable information for depicting a relationship between each of the proposed target values and process capability impact information may be included either in addition or in alternative. In some aspects, process capability impact information may include one or more of other process capability index quantities, such as: Pₚ, Cₚₖ, or Cₚ, or any quantity which approximates any process capability index quantity. In some aspects, process capability impact information may include any one or more of: an out-of-specification rate, an in-of-specification rate, a sigma level, an area under a probability density function, a process yield, a process fallout, or any other suitable quantity for indicating/measuring a production system's overall process capability.

The resource allocation impact information output 270 may display a model of a relationship between each of a number of proposed target values and resource allocation impact information. In the output 270, annual savings (measured in dollars) is plotted as a function of proposed target value reduction (measured in grams) for each of a proposed target value reduction point. The proposed target value reduction points included in output 270 may be the same as the proposed target value reduction points included in output 260.

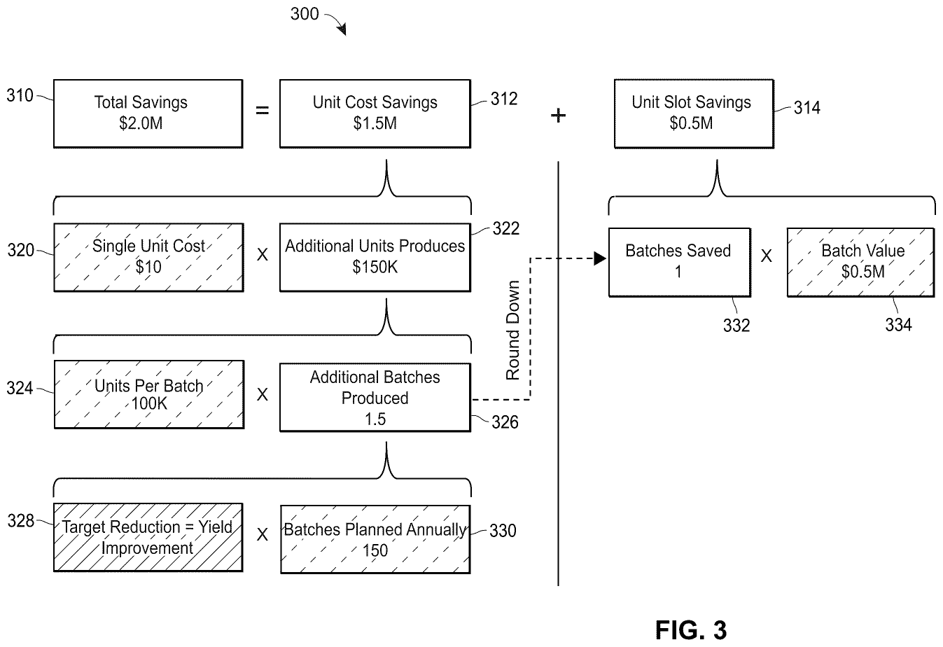

For each proposed target value reduction point in output 270, annual savings is included, as illustrated. Annual savings is one example of information that may be included in resource allocation impact information. Annual savings may be determined in any number of suitable ways for each proposed target value reduction point. As illustrated, annual savings is determined based on inputs 240-246. Further discussion and illustration on examples of how annual savings may be determined is included in FIG. 3.

As illustrated in output 270, as target value reduction increases, annual savings increases, demonstrating that as target value approaches LSL for a production system, less cost will be associated with operation of the production system. As illustrated, the baseline target value has no annual savings (which is by definition, as all other annual savings are compared to the baseline target value's annual savings). Conversely, as illustrated, a target value reduction of 0.05 grams corresponds to an annual savings of over $3,000,000.

While annual savings is illustrated in output 270, any other suitable information for depicting a relationship between each of the proposed target values and resource allocation impact information may be included either in addition or in alternative. In some embodiments, one or more of: raw material usage, energy usage, financial resource usage, labor usage, or other scarce/finite resource usage may be included in resource allocation impact information.

The output interface 250 may be presented to an operator of a production system to provide insight which may aid the operator in selecting target value from the proposed target values which corresponds to a desired balance of resource allocation impact information and process capability impact information. In some embodiments, when applied to applications with at least a LSL, the selected target value may be less than the historical target value, thereby reducing NER usage and providing one or more of the advantages of reducing NER usage as described herein.

### Exemplary Process for Determining Annual Savings for a Proposed Target Value

FIG. 3 depicts an example process 300 for determining annual savings for a proposed target value. Generally, the process 300 included in FIG. 3 is directed to generating a relationship between a respective proposed target value (of each of a plurality of proposed target values) and resource allocation impact information. As previously mentioned, while annual savings may be illustrated as included in resource allocation impact information (specifically as an example of financial impact information), any other suitable resource allocation impact information may be included in addition or instead (e.g., material impact information, energy impact information, labor impact information, throughput impact information, etc.).

The process 300 may be performed using the system 100 (e.g., by the model generating unit 134 of the PSC application 130). The process 300 may use resource allocation input information as input (e.g., inputs 240-246 as illustrated). The output of the process 300 may be included in and/or represented by a model that, for each of a plurality of proposed target values for a given product parameter, models a relationship between a respective proposed target value and both (i) resource allocation impact information and (ii) process capability impact information. The output/model may be displayed using components of the computing device 110, and may be displayed using an output interface which may be the same as or similar to the output interface 250. In some aspects, the output/model may be displayed in the same as or similar manner as the output 270.

In the process 300, exemplary numerical values are included in each of items 310-334. At least some of the exemplary numerical values may correspond to exemplary numerical values included in FIG. 2, in one or both of the input interface 210 or the output interface 250.

In the process 300, input items are illustrated with hatching. The input items include single unit cost 320, units per batch item 324, batches planned annually item 330, and batch value item 334, which may correspond to single unit cost input 240, units per batch input 242, batches planned annually input 244, and batch value input 246, respectively.

A yield improvement item 328 may correspond to one proposed target value reduction of the 15 proposed target value reductions included in FIG. 2. Specifically, as illustrated,

$$Yield Improvement \% = \frac{1}{1 - Target Value Reduction \%} - 1 , \qquad ( Equation 4 )$$

which may be approximated as,

$$Yield Improvement \% \approx Target Value Reduction \% . \qquad ( Equation 5 )$$

Accordingly, each proposed target value reduction may be input as a percentage of a baseline target value into item 328 to calculate, via the process 300, annual savings for each of the proposed target value reductions. The annual savings for each of the proposed target value reductions may correspond to a total savings item 310.

The PSC application 130 may perform the steps of the process 300. Generally, as illustrated, the PSC application: multiplies the yield improvement item 328 with the batches planned annually item 330 to obtain an additional batches produced item 326; (1) multiplies the additional batches produced item 326 with the units per batch item 324 to obtain an additional units produced item 322; (2) multiplies the additional units produced item 322 with the single unit cost item 320 to obtain a unit cost savings item 312; (3) rounds the additional batches produced item 326 down to the nearest integer to obtain a batches saved item 332; (4) multiplies the batches saved item 332 with the batch value item 334 to obtain a unit slot savings item 314; and (5) adds the unit cost savings item 312 with the unit slot savings item 314 to obtain the total savings item 310. The total savings item 310, may correspond to the output 270, specifically corresponding to the y-values for each of the proposed target value reduction points of the output 270.

### Exemplary Impact Information for Select Proposed Target Values

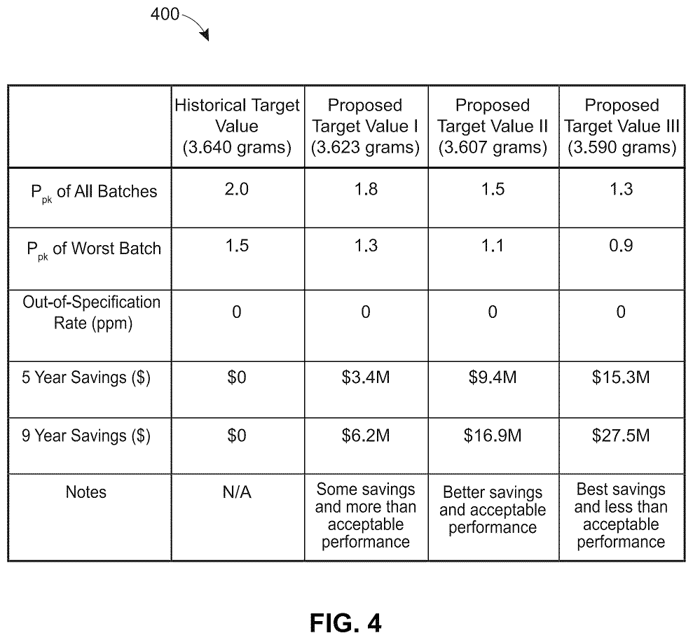

FIG. 4 depicts an example output table 400 relating proposed target values to resource allocation impact information and process capability impact information. Generally, the output table 400 may correspond to a model that, for each of a plurality of proposed target values for a product parameter, models a relationship between a respective proposed target value and both (i) resource allocation impact information and (ii) process capability impact information. In some aspects, the output table 400 itself may be an example of the model. In other aspects, the output table 400 may correspond to the model, such as by being a representation of the model.

The output table 400 may be generated using the system 100, specifically using, for example, the model generating unit 134 of the PSC application 130 stored in the memory 128 of the computing device 110. The output table 400 may be displayed using a graphical display, such as the display 124 of the computing device. In some aspects, the output may be displayed in the same as or similar manner as the output 270 and/or may be displayed alongside the output 270. In some aspects, wherein the output table 400 serves as a representation of the model, the model may serve as input to the output table 400.

In the output table 400, exemplary numerical values are included. At least some of the exemplary numerical values may correspond to exemplary numerical values included in FIG. 2, in one or both of the input interface 210 or the output interface 250. As illustrated, the output table 400 may correspond to data/information included in the output interface 250. Specifically, as illustrated, the output table 400 may include process capability impact information (e.g., Fill Weight Pₚₖ (All batches), Fill Weight Pₚₖ (Worst batches), and Deliverable Volume Out-of-Specification Rate (ppm)) and resource allocation impact information (e.g., 5 Year Savings ($) and 9 Year Savings ($)) corresponding to the baseline target value of FIG. 2 and three proposed target values (e.g., Proposed Target Value I, Proposed Target Value II, and Proposed Target Value III) of the 15 proposed target values of FIG. 2.

As illustrated, Notes are included in the output table 400 which may have been generated due to user input, such as via a keyboard and/or voice commands. In other aspects, the Notes of output table 400 may be generated via artificial intelligence and/or data analytics algorithms which may apply qualitative labels to data included in the output table 400. As illustrated, an Out-of-Specification rate is included in the output table 400. It is worth noting that even if OOS products are produced, this does not necessarily mean that there will be any effect on product acquired by a customer. Products that are OOS may be flagged by a production system and may be discarded.

The output table 400 may be presented to an operator of a production system to provide insight which may aid the operator in selecting target value from the proposed target values which corresponds to a desired balance of resource allocation impact information and process capability impact information. In some aspects, when applied to applications with at least a LSL, the selected target value may be less than the historical target value, accordingly reducing NEV and providing the numerous advantages of reducing NER usage described herein. As illustrated, Proposed Target Value III corresponds to the largest NEV reduction of the four illustrated target values. Accordingly, Proposed Target Value III corresponds to the largest savings for both 5 and 9 years and the lowest Pₚₖ for both all batches and a worst batch. Proposed Target Value I corresponds to less NEV reduction, less savings, and higher Pₚₖ values than Proposed Target Value III. An operator of the production system may use the output table 400 to aid in considering of risk vs. reward, wherein increasing the risk corresponds to lowering the Pₚₖ and increasing the reward corresponds to increasing the savings. As illustrated in the Notes of the output table 400, the operator may select Proposed Target Value II to be the selected target value as it has “better savings and acceptable performance,” while Proposed Target Value I only has “some savings” and Proposed Target Value III has “less than acceptable performance.” The selection of a selected target value may be highly dependent on what the operator values and/or considers important; the numerical values included in FIG. 2-4 may be purely exemplary for illustrative purposes, and do not necessarily correspond to which numerical values for resource allocation impact information and/or process capability impact information are preferable.

### Exemplary Outputs for Product Filling Systems

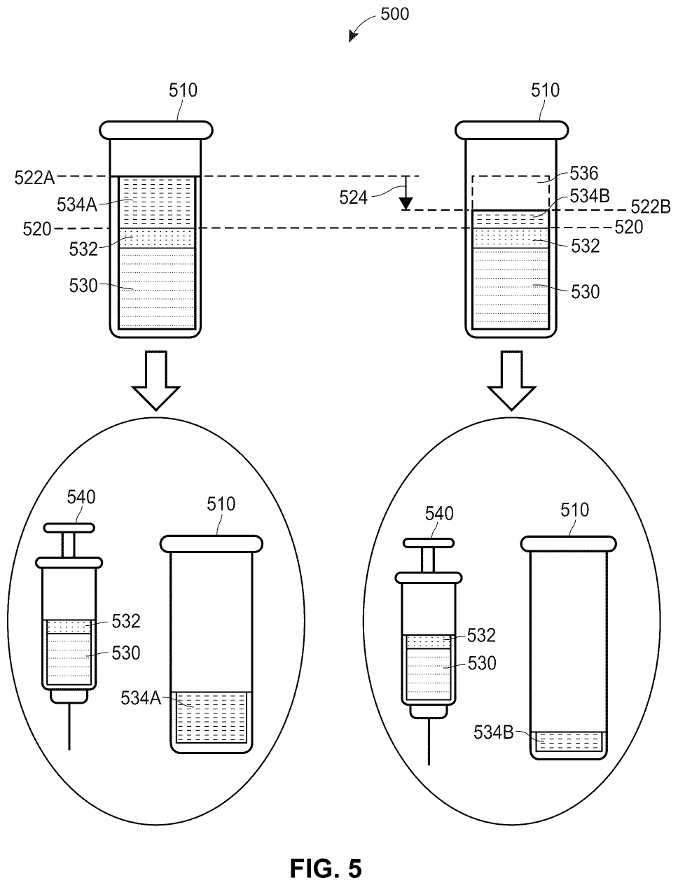

FIG. 5 depicts a comparison diagram 500 between output of a product filling system operating with a historical target value and a selected target value with a lower NEV than the historical target value. The historical target value may be the same as or similar to the Historical Target Value included in output table 400 and the selected target value may be the same as or similar to the Proposed Target Value II included in output table 400.

In some aspects, reducing the historical target value to the selected target value may have been in response to receiving the selected target value via user input (via, e.g., the user interface unit 136 and/or the user input device 126 of the computing device 110) and/or an automatic selection (e.g., via an artificial intelligence or data analysis algorithm). In some aspects, reducing the historical target value to the selected target value may include displaying (via, e.g., the display 124 of the computing device 110) relationship between the selected target value and both (i) resource allocation impact information and (ii) process capability impact information of the selected target value. In some aspects, reducing the historical target value to the selected target value may include causing (via, e.g., the production system operating unit 138 of the computing device 110) the production system (e.g., the production system(s) 140 of the system 100) to operate using the selected target value.

As illustrated, the diagram 500 depicts a product which is a container 510 filled with a drug, in liquid form, by a pharmaceutical production system, wherein the drug is, at a later time, withdrawn into a syringe 540. The drug is comprised of three parts: a label volume 530, a hold-up volume 532, and a historical/selected NEV 534A/B. The label volume 530 may be an amount of the drug which is to be administered to a patient and the label volume 530 may be set by, for example, a regulatory body (e.g., the Food and Drug Administration).

The hold-up volume 532 may be an amount of the drug, which, when the drug is withdrawn from the container 510 into the syringe 540, remains in the syringe 540 after the syringe is fully discharged, and may therefore not be feasibly recovered. While the hold-up volume 532 is illustrated as being entirely in the syringe 540, it is worth noting, in some examples, not all of the hold-up volume 532 may be in the syringe 540 as some of the drug may be left as residual in the container 510 when the drug is withdrawn into the syringe 540. Accordingly, in some examples, a first portion of the hold-up volume 532 may remain in the container 510 and a second portion of the hold-up volume 532 may be withdrawn into the syringe 540.

Line 520 is above the label volume 530 and the hold-up volume 532 and may correspond to a lower specification limit. Line 522A is above the label volume 530, the hold-up volume 532, and the historical NEV 534A. Line 522A corresponds to how much of the drug would be filled into the container 510 to produce the product according to the historical target value. Line 522B is above the label volume 530, the hold-up volume 532, and the selected NEV 534B. Line 522B corresponds to how much of the drug would be filled into the container 510 to produce the product according to the selected target value. Measurement 524 is a measurement of a difference in level of the line 522A and the line 522B. Measurement 524 corresponds to how much of the drug would be saved per unit of the product produced according to the historical target value and the selected target value (this amount is also shown as NEV reduction amount 536).

As shown, by reducing the historical target value to the selected target value, the historical NEV 534A is reduced to the selected NEV 534B by the NEV reduction amount 536. The NEV reduction amount 536 corresponds to an amount of the drug which will be saved per unit of the product produced, which, as discussed herein, corresponds to numerous advantages.

### Exemplary Flow Diagram

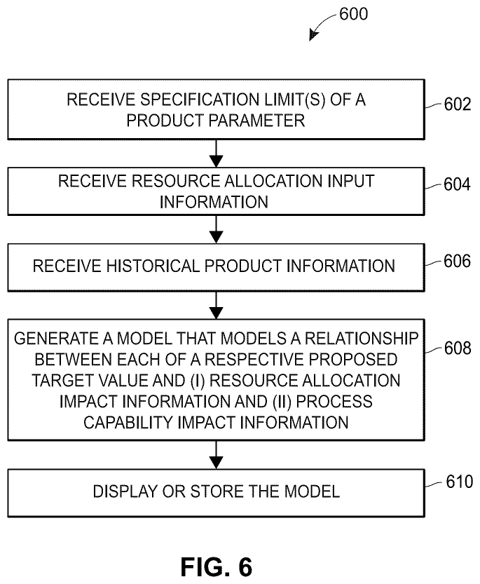

FIG. 6 is a flow diagram depicting an example method 600 for characterizing a recipe of a production system for producing a product. The example method 600 may include the following steps: (1) receive specification limit(s) of a product parameter (block 602), (2) receive resource allocation input information (block 604), (3) receive resource allocation input information (block 606) (4) generate a model that models a relationship between each of a respective proposed target value and both (i) resource allocation impact information and (ii) process capability impact information (block 608), and (4) display or store the model (block 610).

Receiving the specification limit(s) of the product parameter (block 602) may use one or more specification limit sources, such as the specification limit source(s) 160 of FIG. 1 and/or the input interface 210 of FIG. 2, as well as possibly the data collection unit 132 of FIG. 1. The specification limits may include an upper specification limit and/or a lower specification limit for the product parameter with which the product should comply. Specification limits may relate to measurable quantities of product parameters. The product parameters which may be one or more characteristics of length, mass, temperature, time, electric current, luminous intensity amount of substance, etc.

Receiving the resource allocation input information (block 604) may use one or more resource allocation input sources, such as the resource allocation input source(s) 170 of FIG. 1 and/or the input interface 210 of FIG. 2, as well as possibly the data collection unit 132 of FIG. 1. The resource allocation input information may include financial input information (e.g., what are financial costs associated with producing the product), material input information (e.g., how much of a raw material is used in producing the product), energy input information (e.g., how much energy is used in producing the product), labor input information (e.g., how much labor is used in producing the product), or other scarce/finite resource input information.

Receiving the historical product information (block 606) may use one or more historical product information sources, such as the historical product information source(s) 150 of FIG. 1 and/or the input interface 210 of FIG. 2, as well as possibly the data collection unit 132 of FIG. 1. The historical product information may include: (i) a plurality of historical actual values for the product parameter, and (ii) one or more historical target values for the product parameter.

Generating the model that models a relationship between each of a respective proposed target value and both (i) resource allocation impact information and (ii) process capability impact information (block 608) may use a computing device, such as the computing device 110 of FIG. 1. Specifically, within the computing device an application, such as the PSC application 130 with the model generating unit 134 may be used. The model generated may be the same as or similar to (or may be representable in the same as or similar manner to) the outputs 260-270. The computing device may, for example, perform steps which are the same as or similar to those corresponding to the process 300 of FIG. 3 to determine a relationship between each of the respective proposed target values and the resource allocation impact information.

Finally, in the depicted method 600, the model is displayed and/or stored (block 610). In some aspects the model itself may be displayed, while in other aspects a representation of the model may be displayed. Displaying the model may use a computing device, such as the computing device 110 (e.g., specifically using the display 124 and/or the user interface unit 136). In some aspects the model itself may be stored, while in other aspects a representation of the model may be stored. Storing the model may use a computing device, such as the computing device 110 (e.g., specifically using the memory 128).

In some aspects, the method 600 may be performed either entirely by automation, e.g., by one or more processors (e.g., a CPU and/or GPU) that execute instructions stored on one or more non-transitory, computer-readable storage media (e.g., a volatile memory or a non-volatile memory, a read-only memory, a random-access memory, a flash memory, an electronic erasable program read-only memory, and/or one or more other types of memory), or in-part by automation and in-part by manual processes (e.g., via a human operator). The method 600 may use any of the components, processes, and/or techniques of one or more of FIGS. 1-5.

### Additional Considerations

Some of the figures described herein illustrate example block diagrams having one or more functional components. It will be understood that such block diagrams are for illustrative purposes and the devices described and shown may have additional, fewer, or alternate components than those illustrated. Additionally, in various aspects, the components (as well as the functionality provided by the respective components) may be associated with or otherwise integrated as part of any suitable components.

Some aspects of the disclosure relate to a non-transitory computer-readable storage medium having instructions/computer-readable storage medium thereon for performing various computer-implemented operations. The term “instructions/computer-readable storage medium” is used herein to include any medium that is capable of storing or encoding a sequence of instructions or computer codes for performing the operations, methodologies, and techniques described herein. The media and computer code may be those specially designed and constructed for the purposes of the aspects of the disclosure, or they may be of the kind well known and available to those having skill in the computer software arts. Examples of computer-readable storage media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as ASICs, programmable logic devices (“PLDs”), and ROM and RAM devices.

Examples of computer code include machine code, such as produced by a compiler, and files containing higher-level code that are executed by a computer using an interpreter or a compiler. For example, an aspect of the disclosure may be implemented using Java, C++, or other object-oriented programming language and development tools. Additional examples of computer code include encrypted code and compressed code. Moreover, an aspect of the disclosure may be downloaded as a computer program product, which may be transferred from a remote computer (e.g., a server computer) to a requesting computer (e.g., a client computer or a different server computer) via a transmission channel. Another aspect of the disclosure may be implemented in hardwired circuitry in place of, or in combination with, machine-executable software instructions.

As used herein, the singular terms “a,” “an,” and “the” may include plural referents, unless the context clearly dictates otherwise.

As used herein, the terms “approximately,” “substantially,” “substantial,” “roughly” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to +10% of that numerical value, such as less than or equal to +5%, less than or equal to +4%, less than or equal to +3%, less than or equal to +2%, less than or equal to +1%, less than or equal to +0.5%, less than or equal to +0.1%, or less than or equal to +0.05%. For example, two numerical values can be deemed to be “substantially” the same if a difference between the values is less than or equal to +10% of an average of the values, such as less than or equal to +5%, less than or equal to +4%, less than or equal to +3%, less than or equal to +2%, less than or equal to +1%, less than or equal to +0.5%, less than or equal to +0.1%, or less than or equal to +0.05%.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the techniques disclosed herein have been described with primary to particular operations performed in a particular order, it will be understood that these operations may be combined, sub-divided, or re-ordered to form an equivalent technique without departing from the teachings of the present disclosure. Accordingly, unless specifically indicated herein, the order and grouping of the operations are not limitations of the present disclosure.

1. A method for characterizing a recipe of a production system for producing a product, comprising:
receiving, by one or more processors, one or more specification limits of a product parameter of the product;
receiving, by the one or more processors, resource allocation input information;
receiving, by the one or more processors, historical product information for a number of batches, the historical product information including: (i) a plurality of historical actual values for the product parameter, and (ii) one or more historical target values for the product parameter;
generating, by the one or more processors applying the specification limits, the resource allocation input information, and the historical product information, a model that, for each of a plurality of proposed target values for the product parameter, models a relationship between the respective proposed target value and both (i) resource allocation impact information and (ii) process capability impact information; and
displaying or storing, by the one or more processors, the model.

2. The method of claim 1, wherein the production system is a filling system, the product is a liquid, and the product parameter is either a fill weight or a fill volume.

3. The method of claim 2, wherein the product is a drug.

4. The method of claim 1, wherein the specification limits are provided by a regulatory entity.

5. The method of claim 1, wherein the specification limits include one or both of a lower specification limit or an upper specification limit.

6. The method of claim 1, wherein the number of batches is at least 25.

7. The method of claim 1, wherein the historical actual values for the product parameter include, for each batch of the number of batches, one or more of: raw data, a mean, a standard deviation, a minimum value, or a maximum value.

8. The method of claim 1, wherein (i) the resource allocation input information includes one or more of: material input information, financial input information, labor input information, energy input information, or throughput input information, and (ii) the resource allocation impact information includes one or more of: material impact information, financial impact information, labor impact information, energy impact information, or throughput impact information.

9. The method of claim 1, wherein the process capability impact information includes one or more of: a process capability index, an out-of-specification rate, an in-specification rate, an out-of-specification amount, or an in-specification amount.

10. The method of claim 1, further comprising:
receiving, by the one or more processors, a selected target value of the proposed target values.

11. The method of claim 1, further comprising:
automatically selecting, by the one or more processors, a selected target value of the proposed target values.

12. The method of claim 10, further comprising:
displaying, by the one or more processors, a relationship between the selected target value and both (i) resource allocation impact information and (ii) process capability impact information of the selected target value.

13. The method of claim 1, wherein displaying the model includes:
displaying, by the one or more processors for each of the proposed target values, a relationship between the respective proposed target value and both (i) resource allocation impact information and (ii) process capability impact information.

14. The method of claim 10, further comprising:
causing, by the one or more processors, the production system to operate using the selected target value.

15. One or more non-transitory, computer-readable media storing instructions that, when executed by one or more processors, cause the one or more processors to;
receive one or more specification limits of a product parameter of the product;
receive resource allocation input information;
receive historical product information for a number of batches, the historical product information including: (i) a plurality of historical actual values for the product parameter, and (ii) one or more historical target values for the product parameter;
generate, by applying the specification limits, the resource allocation input information, and the historical product information, a model that, for each of a plurality of proposed target values for the product parameter, models a relationship between the respective proposed target value and both (i) resource allocation impact information and (ii) process capability impact information; and
display or store the model.

16. A system comprising:
one or more processors; and
one or more non-transitory, computer-readable media storing instructions that, when executed by the one or more processors, cause the one or more processors to:
receive one or more specification limits of a product parameter of the product;
receive resource allocation input information;
receive historical product information for a number of batches, the historical product information including: (i) a plurality of historical actual values for the product parameter, and (ii) one or more historical target values for the product parameter;
generate, by applying the specification limits, the resource allocation input information, and the historical product information, a model that, for each of a plurality of proposed target values for the product parameter, models a relationship between the respective proposed target value and both (i) resource allocation impact information and (ii) process capability impact information; and
display or store the model.

17. The system of claim 16, wherein the instructions, when executed, cause the one or more processors to:
receive a selected target value of the proposed target values.

18. The system of claim 16, wherein the instructions, when executed, cause the one or more processors to:
automatically select a selected target value of the proposed target values.

19. The system of claim 17, wherein the instructions, when executed, cause the one or more processors to:
display a relationship between the selected target value and both (i) resource allocation impact information and (ii) process capability impact information of the selected target value.

20. The system of claim 17, wherein the instructions, when executed, cause the one or more processors to:
cause a production system to operate using the selected target value.
